(19) United States
(12) Patent Application Publication
(10) Pub. No.: US 2006/0029645 A1
(43) Pub. Date: Feb. 9, 2006

(54) Acid-containing feed supplements for ruminants and methods of manufacturing same

(75) Inventor: Bill Vanderkooi, Abbotsford (CA)

Correspondence Address: Polsinelli Shalton Welte Suelthaus, Suite 1100, 100 South Fourth Street, St. Louis, MO, 63102-1825, US

(73) Assignee: Nutritech Solutions Ltd., Abbotsford (CA)

(21) Appl. No.: 10/910,289

(22) Filed: Aug. 4, 2004

(51) Int. Cl. A23K 1/17

(52) U.S. Cl. 424/442

(57) ABSTRACT

This application relates a flowable feed supplement for ruminant animals such as cattle comprising a liquid acid adsorbed on a granular inorganic substrate. The inorganic substrate may be combined with an organic carrier such as source of slowly fermentable carbohydrates. In one embodiment the inorganic substrate is silicon dioxide. The supplement provides a concentrated, palatable source of anions to help prevent hypocalcemia, ketosis and other diet-related metabolic disorders.

### TECHNICAL FIELD

This application relates to a feed supplements for ruminants such as dairy cattle. The feed supplements are flowable and contain adsorbed liquid acids from organic or inorganic sources. The feed supplements are useful for treatment or prevention of metabolic disorders such as hypocalcemia, milk fever and ketosis.

### BACKGROUND

Ruminants such as dairy cattle are prone to various diet-related metabolic disorders. For example, a dairy cow's blood can become deficient at calving since a tremendous amount of calcium is put into colostrum and milk. Severe cases of hypocalcemia result in milk fever. Milk fever is a metabolic disorder in which calcium homeostatic mechanisms fail to maintain normal plasma calcium concentrations at the onset of lactation. It is estimated that milk fever may affect up to 10% of calving cows. As cows become older, the incidence of milk fever increases dramatically, likely due to decline in the ability to mobilize calcium from bone stores and a decline in the active transport of calcium in the intestine. Left untreated, milk fever is a serious condition resulting in disruption of neuromuscular function and ultimately animal death in severe cases.

One of the most widely used treatments for milk fever is to infuse calcium borogluconate solutions into the affected cattle. Although this treatment is usually effective, it is relatively expensive to administer and may result in overly high concentrations of plasma calcium, triggering cardiac arrest in some animals.

Less severe cases of hypocalcemia at calving can result in feed intake depression and poor muscle tone which in turn can predispose cattle to other secondary medical conditions such as retained placenta, displaced abomasums, ketosis and mastitis.

Diet (notably, cations in the diet) is believed to be a contributing factor to the onset of milk fever. The prepartum diet of dairy cattle often includes alfalfa which has a high concentration of potassium. It has been shown that cations, particularly potassium, have the effect of reducing absorption of calcium and magnesium into the blood, thereby resulting in greater demand for these minerals. Reducing dietary potassium and adding anions (specifically chlorides) to the close-up dry cow diet increases calcium mobilization and absorption and re-establishes proper blood calcium levels.

Various strategies for preventing milk fever have been proposed which attempt to maintain an appropriate dietary cation/anion difference (DCAD) at the onset of lactation. One approach is to feed inorganic acids, such as a combination of sulphuric and hydrochloric acids, to cows prepartum. Although this approach is effective, such inorganic acids are too dangerous and difficult to use on a farm in their concentrated liquid form. Another option is to supplement the diet of dairy cattle with anionic salts. Commonly used sources of anions include the Cl— and SO₄²— salts of calcium, ammonium and magnesium. However, anionic salts are often not palatable to cattle which limit their effectiveness.

Beet pulp and canola have been used as a dry matter carrier for hydrochloric acid in some dairy feed additives. The Applicant manufactures and sells an anionic feed additive under the trademark NutriChlor 18-8® in which the chloride fraction is carried on a beet pulp and canola meal base. The NutriChlor 18-8 product is very effective, but suffers from several drawbacks. In particular, the chloride fraction cannot be highly concentrated on such organic substrates for economical transport to distant customers. Because of the necessary addition of moisture that is contained within the hydrochloric acid, the blended product containing hydrochloric acid must be subsequently dried to produce a dry and flowable product acceptable for transport from the manufacturing facility to farms. This drying adds expense and results in the loss of volatile hydrochloric acid which further reduces product efficacy and poses health risks to workers involved in the manufacturing process.

Dairy cattle and other ruminants are also prone to other diet-related metabolic disorders, such as ketosis. The potential for a lactating ruminant to produce milk is largely dependent on energy supply. The nature of energetic materials supplied is as important as the total amount of energy available for milk production. Glucose is essential for milk synthesis and at around the time of parturition, glucose usage exceeds glucose supply (Overton, 2002). Unlike other mammals, ruminants are limited in their ability to synthesize glucose. If insufficient glucose is supplied, ruminants will develop ketosis. Therefore, energy has to be provided by diets in the form of propionic acid, resulting from rumen fermentation, or glucose absorbed from the intestine. The propionic acid is produced in the rumen via fermentation of readily available non-structural carbohydrates, such as starch, by rumen bacteria. Feeding high levels of non-structural carbohydrates can result in an accumulation of lactic acid in the rumen. High levels of lactic acid in the rumen tend to lower rumen pH which could lead to ruminal acidosis and laminitis (Owens et al., 1998).

To circumvent the risks to animal health associated with over-feeding fermentable carbohydrates, attempts have been made to feed propionic acid directly. However, propionic acid is corrosive and highly volatile, producing noxious odors. Therefore, only low concentrations of the propionic acid can be used (typically less than 1%). To overcome this, salts of organic acids, such as calcium propionate, have been used to reduce odor and corrosiveness. A calcium propionate paste has been reported as a useful aid to prevent milk fever and hypocalcemia in periparturient dairy cows (Goff et al., 1996). However, these salts are extremely expensive which reduces their usefulness.

Another approach would be to provide other organic acids that are converted to propionic acid in the rumen. For example, the ruminant diet may be supplemented with malic acid and fumaric acid which can be converted to propionic acid by rumen bacteria (Lopes et. al., 1999). The practical problem with feeding these organic acids is that they are corrosive in their liquid form and too expensive in their dry form or as salts. Therefore, given the current state of the art, organic acids are impractical to use.

There is a need for delivering liquid acids into the diets of ruminants in a form that is more concentrated, palatable and cost-effective than is permitted by the current state of the art. Flowability is also a concern. Liquid acids necessarily contain moisture. When these acids are combined with dry ingredients, the resultant feedstuff will clump and be difficult to transport, thus creating an undesirable product. Also, when moisture content in the feed is greater than about 15%, the feed is susceptible to mold growth which reduces palatability and may result in the production of toxic substances by the mold. One solution is to apply heat to drive off the excess moisture. However, this step adds additional cost and will result in the volatilization and loss of valuable acids (such as hydrochloric and propionic acids). The heating in the drying process is further undesirable because the heat has detrimental effects on the nutritional value of the feedstuff. Therefore, there is a need a system to provide liquid acids into feeds in a dry and flowable form. The present invention describes a method and product whereby liquid acids are combined in high concentration with dry inorganic and organic carriers so that the resulting feed is flowable, palatable and stable without the need for drying and its subsequent loss of valuable nutrients.

The use of inorganic carriers such as silicon dioxide in feed supplements is known in the prior art. For example, U.S. Pat. No. 4,842,863, Nishimura et al., which issued on Jun. 27, 1989, describes a granular agent for a ruminant comprising at least one physiologically active substance. Fine solid particles of silicon dioxide powder may be embedded in a thin surface film of the granular agent. As described in a related continuation-in-part case, U.S. Pat. No. 5,635,198, Nishimura et al., which issued on Jun. 3, 1997, the granular agent may be coated with hardened animal or vegetable fat. U.S. Pat. No. 6,306,427, Annonier et. al., also describe a method of making a hardened granular pellet that contains a binding agent which may include, among other compounds, silica and certain silicates. However, these patents relate to feed additives which are intended for bypassing rumen digestion rather than regulating dietary cation/anion ratios and preventing metabolic diseases.

European Patent No. 219997 describes a preservative composition for adding to animal feedstuff comprising a binary blend of formic acid and propionic acid. The aqueous blend of acids is impregnated in a solid carrier such as silica. 0.1-10% of the blend is used in feed for pigs, cattle or poultry. One disadvantage of the additive is that the percentage of active agent on the carrier is rather low. Further, due to the poor thermal stability of the product, there is a high risk of loss of the acid during production and storage. U.S. Pat. No. 5,660,852, Mckeown et al., describes a combination of gluconeogenic precursors such as propionic acid, in combination with long chain fatty acids. However, this invention requires extensive mechanical processing in combination with costly fats.

U.S. Pat. No. 6,136,338, Danielson et al., describes a method of administering an antibiotic such as fluoroquinolone so that it can be absorbed through the rumen wall. In this case, inert carriers such as silica are used. In this case, the silica provides no functionality other than to act as an inert carrier. Additionally, the invention relates to providing an antibiotic that has a specific action against specific species of bacteria and does not relate to metabolic disorders resulting from mineral imbalances.

Silica and other silicates have been used as hardening agents in animal feeds (U.S. Pat. No. 4,234,608, Linehan; U.S. Pat. No. 4,988,520, Overton; and U.S. Pat. No. 5,908,634, Kemp et al.) whereby combinations of silicates and other mineral containing compounds are combined with heat to increase the hardness of pellets and feed blocks for ruminants. While this process is beneficial in providing a physically hard composition, it has the drawback in that the binding and crosslinking between minerals that produces the hardness reduces mineral availability.

U.S. Pat. No. 6,355,278, Stidham et al., describes a process whereby hydrochloric acid is combined with a dry carrier and mixed with limestone followed by a heating process to drive off excess moisture. The limestone is essential to react with the hydrochloric acid to prevent volatilization during the drying process.

U.S. Pat. No. 4,161,539, Stallcup, describes the use of malic acid to improve growth rate, milk production and feed efficiency in ruminants. A wide range of methods of oral dosage are described, but none are economically practical for liquid acids in high concentrations. U.S. Pat. No. 6,033,689, Waterman et. al., describes an improvement on Stallcup's process whereby relatively low concentrations of malic acid (about 1.8%) are combined with specific concentrations of whey and soluble carbohydrates to increase ruminal pH. This invention requires the feeding of detrimentally high levels of added protein to provide nutritionally significant quantities of organic acids.

The need has therefore arisen for a flowable feed additive comprising an organic or inorganic liquid acid adsorbed on an inert inorganic carrier that can be combined with other organic and inorganic ingredients without the loss of efficacy and palatability.

### SUMMARY OF THE INVENTION

In accordance with the invention, a flowable animal feed supplement for ruminants such as dairy cattle is provided. The supplement comprises a liquid acid adsorbed on a granular inorganic substrate, such as silica, silicon dioxide or sodium bentonite. Preferably the inorganic substrate is capable of adsorbing between 50 and 500% of its weight in moisture.

In one embodiment the inorganic substrate comprises between 0.1% to 5% of the dry mass of the feed supplement. The liquid acid may comprise within the range of 5% to 60% of the dry mass of the feed supplement. The liquid acid may consist of an inorganic acid, such as hydrochloric acid, or an organic acid, such as propionic acid or malic acid.

Preferably the feed supplement further comprises organic material consisting of slowly fermentable carbohydrates. Suitable organic material includes beat pulp, soybean hulls and alfalfa meal. In one embodiment the organic material is capable of adsorbing between 10 and 100% its weight in moisture and comprises approximately 35% to 95% of the dry mass of the feed supplement.

The feed supplement may also optionally include further inorganic additives such as limestone, ammonium chloride and calcium chloride.

A method for manufacturing the feed supplement is also described which includes the steps of mixing a supply of organic material comprising slowly fermentable carbohydrates; spraying liquid acid on to the organic material while continuing to mix the organic material; and adding an inorganic substrate to the mixture, wherein the liquid acid is substantially adsorbed by the organic material and the inorganic substrate to yield a flowable feed supplement. The method may further include the step of adding one or more inorganic additives to the mixture, such as limestone, ammonium chloride and calcium chloride.

Methods of preventing hypocalcemia and/or ketosis are also described comprising feeding to the cattle a biologically effective amount of the feed supplement.

### DETAILED DESCRIPTION

The application relates to a feed supplement for ruminants such as dairy cattle. The supplement provides a concentrated, palatable source of liquid acid in a flowable form to help prevent metabolic disorders such as hypocalcemia and ketosis in cattle. The liquid acid is provided on an inert inorganic substrate such as silicon dioxide. The inorganic substrate may be in the form of dry granules and may be optionally coated with mineral oil.

The supplement is further preferably comprised of dry organic material in the form of slowly fermentable carbohydrates. Suitable organic material include soybean hulls, beet pulp and alfalfa meal. The acid is preferably applied in a spray as described below and is adsorbed by both the inorganic and organic carriers.

As used in this patent application the term “liquid acid” means an acid which is present in the supplement in the liquid phase. For example, substantially all of the liquid acid may be physically adsorbed on the surface of a solid substrate. The term “liquid acid” may include both inorganic acids, such as hydrochloric acid, and organic acids such as malic acid.

As used in this patent application the term “flowable” means a feed supplement that is free flowing and resists clumping. Such supplements are suitable for economical freighting in a dry form.

### EXAMPLES

The following examples will illustrate the invention in further greater detail although it will be appreciated that the invention is not limited to the specific examples.

Table 1 below summarizes the composition of the applicant's feed supplement according to one embodiment of the invention in dry concentrate form.

TABLE 1

| Ingredient | % of DM (dry mass) |
|---|---|
| Silicon dioxide | 2.0 |
| Liquid acid | 15.0 |
| Beet pulp | 26.0 |
| Soybean hulls | 51.0 |
| Calcium chloride | 3.0 |
| Ammonium chloride | 3.0 |

The applicant's feed supplement has superior material handling and flow characteristics. The feed supplement is stable and can be economically freighted to end users. The dry form allows for flexibility in terms of delivery into the feed either at a feed manufacturing facility or a farm. Since the liquid acid is provided in a palatable “pure” concentrated form without the requirement for heating and drying, the moisture content within the feed eliminates the disadvantages of some dry organic carriers, such as excessive dust. Further, undesirable metabolic side effects are avoided since the silicon dioxide carrier is biologically inert.

### Manufacturing Process Example

A stationary mixer is used to combine all ingredients. First, 400 kg of beet pulp is added to the mixer and the mixing process is started. Next, 950 kg of soybean hulls are added to the mixer and the mixing process is continued. After 2 minutes of mixing, 350 kg of concentrated hydrochloric acid is sprayed into the mixing chamber while continuous mixing continues. Upon completion of the hydrochloric acid addition, a further 5 minutes of mixing occurs to ensure that the hydrochloric acid has substantially adsorbed to the organic matrix. The resultant material is transferred by auger to a second mixer where 22 kg of silica is added and the resultant material is mixed for 2 minutes. While mixing continues, optional inorganic materials may be added, including limestone (15 kg), ammonium chloride (38 kg) and calcium chloride (10 kg). Mixing continues for 5 minutes after the last ingredient has been added. The resulting finished product is transferred by auger to a holding bin until it is placed into bags for shipment.

In an alternative embodiment of the invention, the hydrochloric acid may be applied first to the silica or other inorganic substrate and the organic material may be subsequently added to the mixture. The mixing sequence may therefore vary without departing from the invention.

### Flowability Test

A cylinder 6 cm×15 cm (diameter×height), open at both ends was used to measure the effect of the invention on flowability. The cylinder was filled with (a) the applicant's Nutrichlor 18-8® product formulated without silica; and (b) a product formulated according to Table 1 including 2% added silica prepared in accordance with the above-described invention. The material was compressed until the volume was reduced to the 10 cm in height. The cylinder was then removed by removing the compression, then lifting vertically, letting the material stand on its own in the cylindrical form.

The Nutrichlor 18-8 product prepared without silica maintained its cylindrical shape, having a diameter of 6 cm and a height of 11.5 cm. By contrast, the supplement containing 2% silica prepared in accordance with the described invention collapsed into a pyrimidical shape with a height of 2.5 cm and a diameter of 12.5 cm. This experiment demonstrates that material made without the invention is susceptible to becoming compacted during transportation and handling, and is resistant to being free-flowing. When similar material is made using the described invention, it is free flowing and highly renders the product useful for transporting and handling liquid acids in a dry form.

As will be apparent to those skilled in the art in the light of the foregoing disclosure, many alterations and modifications are possible in the practice of the invention without departing from the spirit or scope thereof. Accordingly, the scope of the invention is to be construed in accordance with the substance defined by the following claims.

### REFERENCES

Overton, T. R. 2002. Transition Cow Programs—Management And Metabolism. Proc. Southwest Nutrition Conference. Phoenix, Ariz.

Owens F. N., Secrist, D. S., Hill, W. J. and Gill, D. R. 1998. Acidosis in cattle: a review. J Anim Sci. 76:275-86.

Goff, J. P., R. L. Horst, P. W. Jardon, C. Borelli, and J. Wedam. 1996. Field trials of an oral calcium propionate paste as an aid to prevent milk fever in periparturient dairy cows J. Dairy Sci. 79:378-383

Lopez S, Valdes C, Newbold C J, Wallace R J. 1999. Influence of sodium fumarate addition on rumen fermentation in vitro. Brit. J. Nutr. 81:59-64

What is claimed is:

1. A flowable animal feed supplement for ruminants comprising a liquid acid adsorbed on a granular inorganic substrate.

2. The feed supplement as defined in claim 1, wherein the inorganic substrate is capable of adsorbing between 50 and 500% of its weight in moisture.

3. The feed supplement as defined in claim 1, wherein the inorganic substrate is selected from the group consisting of silica, silicon dioxide and sodium bentonite.

4. The feed supplement as defined in claim 1, wherein the inorganic substrate is within the range of 0.1% to 5% of the dry mass of the feed supplement.

5. The feed supplement as defined in claim 1, wherein the liquid acid is within the range of 5% to 60% of the dry mass of the feed supplement.

6. The feed supplement as defined in claim 5, wherein the liquid acid comprises 15% or more of the dry mass of the feed supplement.

7. The feed supplement as defined in claim 1, wherein the liquid acid is hydrochloric acid.

8. The feed supplement as defined in claim 1, wherein the liquid acid is selected from the group consisting of malic acid, propionic acid and fumaric acid.

9. The feed supplement as defined in claim 1, further comprising organic material consisting of slowly fermentable carbohydrates.

10. The feed supplement as defined in claim 9, wherein the organic material is selected from the group consisting of beat pulp, soybean hulls and alfalfa.

11. The feed supplement as defined in claim 9, wherein the organic material is capable of adsorbing between 10 and 100% its weight in moisture.

12. The feed supplement as defined in claim 9, wherein the organic material is within the range of 35% to 95% of the dry mass of the feed supplement.

13. The feed supplement as defined in claim 9, further including inorganic additives selected from the group consisting of limestone, ammonium chloride and calcium chloride.

14. The feed supplement as defined in claim 5, wherein the inorganic substrate comprises approximately 2% of the dry mass of the feed supplement.

15. A method of manufacturing a feed supplement as defined in claim 9 comprising:
(a) mixing a supply of organic material comprising slowly fermentable carbohydrates;
(b) spraying liquid acid on to the organic material while continuing to mix the organic material; and
(c) adding an inorganic substrate to the mixture,
wherein the liquid acid is substantially adsorbed by the organic material and the inorganic substrate to yield a flowable feed supplement.

16. The method as defined defined in claim 15, further comprising adding inorganic additives selected from the group consisting of limestone, ammonium chloride and calcium chloride to the mixture.

17. The method as defined in claim 16 wherein the inorganic substrate is selected from the group consisting of silica, silicon dioxide and sodium bentonite.

18. The method as defined in claim 17, wherein the liquid acid is selected from the group consisting of hydrochloric acid, malic acid, propionic acid and fumaric acid.

19. A method of preventing hypocalcemia in dairy cattle comprising feeding to said cattle a biologically effective amount of the feed supplement of claim 7.

20. A method of preventing ketosis in dairy cattle comprising feeding to said cattle a biologically effective amount of the feed supplement of claim 8.

21. The method of claim 19, wherein said feed supplement is fed to said cattle for between one and 28 days and preferentially for 21 prior to calving.

22. The method of claim 20, wherein said feed supplement is fed to said cattle at a rate of between 75 grams to 150 grams of supplement per animal per day.
